(19) United States
(12) Patent Application Publication
(10) Pub. No.: US 2026/0359406 A1
(43) Pub. Date: Nov. 12, 2026

(54) System and Method for Real-Time Behavioral Authorship Verification

(71) Applicant: Alvin Williams, JR., Philadelphia, PA (US)

(72) Inventor: Alvin Williams, JR., Philadelphia, PA (US)

(21) Appl. No.: 19/204,522

(22) Filed: May 10, 2025

(51) Int. Cl. G06F 21/31

(52) U.S. Cl. CPC G06F 21/316

(57) ABSTRACT

A multi-modal real-time authorship verification system that captures behavioral input signals during content creation, scores identity match confidence, and tracks session integrity through a behavioral fingerprint and chain-of-custody. Applicable in education, employment, legal, and compliance scenarios, it enables a secure, privacy-respecting method of ensuring that the content was authored by the individual on record, even in live and unsupervised environments.

### CROSS-REFERENCE TO RELATED APPLICATIONS

Not applicable.

### STATEMENT REGARDING FEDERALLY SPONSORED RESEARCH OR DEVELOPMENT

None.

### 0001. FIELD OF THE INVENTION

This invention relates to behavioral biometrics and real-time authorship verification. Specifically, it enables live identity tracking during document creation using keystroke dynamics, stylometric analysis, metadata, and signal integrity scoring within a multi-modal behavioral framework.

### 0002. BACKGROUND OF THE INVENTION

Current systems for plagiarism detection and AI content analysis do not confirm who wrote the content—only whether it appears similar to other sources. With the rise of AI-assisted writing, there is an urgent need for real-time behavioral identity verification during content creation. The invention addresses this by verifying authorship as a behavioral signature, captured live and scored against known patterns. This invention builds upon concepts related to behavioral authorship scoring, including those described in the applicant's prior work on integrated scoring systems, without claiming continuation or dependency on any earlier filing.

### 0003. SUMMARY OF THE INVENTION

This invention introduces a multi-modal real-time verification system that integrates multiple behavioral signals—including typing dynamics, stylometric tendencies, session metadata, error correction patterns, and optional voice or stylus input—into a composite behavioral fingerprint. The system continuously generates a real-time authorship confidence score by comparing live input against stored behavioral baselines or dynamic session profiles. Session metadata, user IDs, and timestamps are recorded in a digital chain-of-custody ledger. Optionally, a session hash can be generated for immutable authorship proof. The system also includes an API integration layer, enabling seamless connection to third-party platforms such as learning management systems (LMS), human resources software, certification testing environments, and compliance tracking systems. This allows the authorship verification engine to function invisibly within institutional workflows.

### 0004. System Components

The system includes the following components:
Input Layer: Captures real-time typing, voice, or pen motion input.
Session ID Generator: Assigns a unique ID to each authorship session.
Behavioral Fingerprint Engine: Builds identity profiles using multi-modal input behavior.
Scoring Engine: Produces match confidence scores based on combined signal inputs.
Session Replay Engine: Records a full behavioral timeline for each document.
Chain-of-Custody Ledger: Tracks time, identity, and device metadata.
Cryptographic Hashing: Optional proof-of-session.
Consent Protocol: Ensures lawful data collection.
Consistency Engine: Tracks behavioral drift and manipulation attempts.
Confidence Score Display: Outputs numerical and color-coded verification.
API Integration Layer: Enables secure, real-time connectivity with third-party LMS, HR, and certification systems to allow authorship scoring to operate within existing platforms.

### 0005. Use Cases

Education: Authorship verification for classroom writing, exams, and remote learning scenarios, including both open and secure testing environments.
Employment: Resume authorship or onboarding integrity.
Certification: Authorship of licensing exams.
Legal: Authorship of affidavits and testimony.
Government: Identity assurance during sensitive documentation.
Compliance: Secure authorship logging in regulated environments.

1. A method for capturing real-time behavior signals during authorship, comprising:
utilizing a consistency engine to track behavior drift;
employing longitudinal behavior identity tracking;
employing one or more user consent protocol; and
utilizing a cryptographic hashing tool for authorship sealing.

2. A system, comprising:
a behavioral fingerprint engine and scoring module;
a replay engine for visual session auditing;
a chain-of-custody ledger with session metadata;
a real-time confidence score interface; and
one or more system integrations with LMS, HR, or testing platforms.

3. (canceled)

4. (canceled)

5. (canceled)

6. (canceled)

7. (canceled)

8. (canceled)

9. (canceled)

10. (canceled)

11. A multi-model behavior authorship scoring system comprising at least two concurrent input modalities, including but not limited to typing dynamics, stylometry, voice input, pen motion, device metadata, or any behavior signal that enables authorship verification, wherein authorship is verified through composite behavior signal matching in real-time.
